(19) United States
(12) Patent Application Publication
(10) Pub. No.: US 2008/0203943 A1
(43) Pub. Date: Aug. 28, 2008

(54) Lighting Device

(75) Inventors: Hans Baaijens, Eindhoven (NL); David Copplestone Payne, Virginia Water (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,778

(22) PCT Filed: Jun. 9, 2006
(86) PCT No.: PCT/IB2006/051841

§ 371 Date: Dec. 17, 2007

(30) Foreign Application Priority Data
Jun. 17, 2005 (EP) 05105380.9

(51) Int. Cl. H05B 37/02; H05B 41/38; H05B 33/08

(52) U.S. Cl. 315/291

(57) ABSTRACT

In a lighting device equipped with three light sources supplying red, green and blue light respectively, the color and/or intensity of the light generated by the three light sources together can be adjusted by means of adjustment points. The colors corresponding to the adjustment points are chosen so that for a fraction of the adjustment points the color difference calculated in the CIELAB space between the colors corresponding to adjacent adjustment points is the same. An inexperienced user can easily find a desired color setting since the change in color perceived by the user is the same for all the adjustment points belonging to said fraction.

The invention relates to a lighting device comprising:

a lighting unit comprising light sources for generating red, green and blue light,

ballast circuitry for supplying supply currents to the light sources in the lighting unit,

a control circuit for controlling the operational state of the ballast circuitry by adjusting one or more operational parameters, and

a user interface, coupled to the control circuit, for adjusting the color or the color and intensity of the light generated by the lighting unit, said user interface being provided with a sensing device for sensing a user action resulting in an output signal of the user interface, said output signal adjusting the operational parameters via the control circuit, said sensing device being provided with a number of adjustment points where a user action is possible, each of the adjustment points corresponding to a different color and/or intensity of the light generated by the lighting unit.

Such a lighting device is known from WO 03/015067 A1. The light sources in the lighting unit may for instance comprise discharge lamps or LED's generating red, green and blue light. The ballast circuitry may comprise a number of discharge lamp drivers, for instance a separate lamp driver for each discharge lamp or for all the discharge lamps of a particular color. Similarly the ballast circuit may comprise a number of LED drivers. In practice, LED's of the same color are often combined into LED arrays. Each LED array can be equipped with its own LED driver. Alternatively, a single LED driver may supply a number of LED arrays comprising LED's of the same color. Consequently, the operational parameters, adjusted by the control circuit to adjust color and/or intensity, are parameters controlling the currents through the discharge lamps of different color or similarly through the LED's of different color. In case the discharge lamps are fluorescent lamps and the discharge lamp drivers are high frequency lamp drivers, the current through the lamps can for instance be adjusted by adjusting the frequency of operation (and thereby the frequency of the lamp current) of such a high frequency lamp driver. Alternatively it is possible to modulate the amplitude of the high frequency lamp current at a low frequency, in other words switch the high frequency current on and off at a low frequency. In that case the duty cycle of the modulation determines the average current through the discharge lamp and thereby the amount of light it generates. Operating frequency and modulation duty cycle are operational parameters of the ballast circuit that can be used for color control respectively in these examples. In case the light source comprises LED's, and the LED driver is a switch mode power supply, the amplitude of the current through the LED's can be adjusted by adjusting the duty cycle(s) of the switch(es) comprised in the switch mode power supply. Alternatively the average current through the LED's can be adjusted by modulation of the LED current amplitude. These different ways of controlling the current through a light source are well known in the art. In these examples the duty cycle of the switch(es) and the duty cycle of the modulation of the LED current amplitude are operational parameters that can be used for color control. The color or the color and intensity of the light generated by the light source are adjusted by adjusting the ratio and/or the amplitudes of the currents through the discharge lamps or LED's of different color.

In case the light source comprises for instance LED's of three different colors, the user of the lighting device could in principle adjust any desired color and intensity by adjusting for instance the duty cycles of the switches comprised in the LED drivers (to adjust the amplitude of the LED current) and/or the duty cycles of the modulations of the currents through the red LED's, the green LED's and the blue LED's. In practice, however, it is very difficult for an untrained user to arrive at a desired color and intensity by adjusting so many different parameters at a desired value. This problem can be alleviated by offering the user a user interface equipped with a sensing device comprising a number of adjustment points, each of said adjustment points for instance corresponding with a different color of the light generated by the LED's. The user can now find the color of the light he desires by trial and error by subsequently activating adjustment points, choosing a next adjustment point based on the color resulting from the activation of the previous adjustment point. Some further help can be offered to the user by mapping the adjustable colors on the surface of the sensing device so that the user has a somewhat better impression of the color of the light associated with each adjustment point. It is for instance possible to map the CIE chromaticity diagram on the surface. Even in this latter case, however, a serious problem, that is still associated with such a prior art user interface, is that some adjacent adjustment points on the surface of the sensing device can correspond to different light colors that the human eye can hardly discriminate, while other adjacent adjustment points can correspond to light colors that are totally different in the perception by the human eye.

As a consequence it is still problematic for an untrained user to arrive at the desired color making use of such a prior art user interface.

The invention aims to provide a lighting device comprising a user interface that enables an untrained user to arrive at a desired color or color and intensity in a comparatively easy and intuitive way.

A lighting device as mentioned in the opening paragraph is for that purpose characterized in that the lighting device is equipped with a memory for storing a color table, each adjustment point corresponding to an element of the color table and each element of the color table comprising data determining the values of the operational parameters of the ballast circuitry corresponding to the adjustment point, and in that the color difference calculated in the CIELAB color space between the color points of the generated light corresponding to adjacent adjustment points is the same for a fraction of the adjustment points. The CIELAB color space is described in detail in literature, e.g. “Principles of color technology” by R. Berns (2000). The CIELAB space is 3-dimensional and a color point is thus characterized by two parameters (such as hue and saturation) representing the color and a third parameter (such as brightness) representing the light level. These three parameters are the coordinates of the color point. To calculate these coordinates a reference color needs to be defined. This can for instance be the white color point at maximum light output. The color difference between two color points can be calculated as the Euclidean norm of the difference vector between the two color points in this space. The CIELAB equation for color differences can be modified with weighing factors for some parts of the color table, to improve the experience f the user that color and intensity changes are perceived as equal. An example is the CIE94 equation (see Berns, page 121) for color difference, but other equations can be used as well.

The colors corresponding to the adjustment points are chosen such that the color differences between colors corresponding to adjacent adjustment points in the CIELAB space are the same for a fraction of the adjustment points. The important advantage of this is that a user can change the color of the light in a number of steps that are perceived as equidistant. In other words the change in color perceived by the user is identical for each step. This enables even an inexperienced user to easily seek through the available colors and find a desired setting of color or color and intensity.

The following is remarked. The colors of the three light sources comprised in the lighting unit define a triangle in the CIE Chromaticity Diagram. The color of the light generated by the lighting unit is always somewhere on the surface of this triangle. It is observed that, in case the total light output of the three light sources together is chosen equal to or lower than the maximum light output of each of the three light sources separately, the color of the light generated by the lighting unit can in principle be made equal to any color within the triangle (assuming that the light output of each light source can be adjusted at any value between zero and maximum light output). As a consequence, the colors corresponding to the adjustment points can be chosen so that the fraction for which the change in color of the generated light as perceived by the user is substantially the same for adjacent adjustment points can be high and even equal to 1. However, in case the total light output of the three light sources together is chosen higher than the sum of the maximum light outputs of each of the three light sources, the color of the light generated by the lighting unit can not be made equal to any color within the triangle. In this case the fraction of the adjustment points for which the change in color of the generated light as perceived by the user is substantially the same for adjacent adjustment points equals zero.

In case the total light output of the three light sources is chosen lower than the sum of the maximum light outputs of the three light sources but higher than the maximum light output of each of the three light sources separately, the color of the light generated by the lighting unit can be made equal to part of the colors within the triangle. In this case fraction of the adjustment points for which the change in color of the generated light as perceived by the user is substantially the same for adjacent adjustment points is generally between 0 and 1. In embodiments of a lighting device according to the invention in which the adjustment points control only the color of the light and the lighting device is equipped with separate means to adjust the light intensity of the three light sources together, the fraction will generally decrease, in case the light intensity is adjusted at a higher level. In other words the advantages of the present invention do not exist for part of the adjustment points at such a comparatively high level of the light intensity. In practice this is often true for part of the adjustment points at an installed light output higher than the maximum intensity of each of the light sources separately.

Generally a certain color can be identified by means of it hue and its saturation or by means of its x-value and y-value, in other words its coordinates in the CIE chromaticity diagram. Preferred embodiments of a lighting device according to the invention are embodiments in which one or more of the following conditions are met: part of the adjustment points corresponds to light with the same color but different intensity; part of the adjustment points corresponds to light with the same intensity but different color; part of the adjustment points corresponds to light with the same color saturation but a different hue; part of the adjustment points corresponds to light with the same hue but a different color saturation. In each of these preferred embodiments a user can adjust one color parameter at a desired value first and subsequently the next color parameter.

In a further preferred embodiment of a lighting device according to the invention, the adjustment points are present on a surface comprised in the sensing means and the color difference calculated in the CIELAB color space between the generated light corresponding to adjacent adjustment points in a first direction is the same and equal to a first value for at least part of the adjacent adjustment points in said first direction and the color difference calculated in the CIELAB color space between the generated light corresponding to adjacent adjustment points in a second direction is the same and equal to a second value for at least part of the adjacent adjustment points in said second direction. The adjustment points can for instance be arranged in the shape of a rectangular table representing the color table. It is noted that the first value and the second value do not need to be equal. Preferably adjacent adjustment points on the surface of the sensing device correspond to adjacent elements in the rows or columns of the color table. However, a separate table and/or formula can be used to determine the relation between adjustment points and elements of the color table. (Equidistant adjustment points are not necessarily neighbors in the color table).

For the same reason as explained here above, the part of the adjustment points in the first direction for which the color difference between adjacent adjustment points in the CIELAB space is equal to the first value will generally be higher when the light output of the lighting unit is chosen lower. The same is true for the part of the adjustment points in the second direction for which the color difference between adjacent adjustment points in the CIELAB space is equal to the second value.

The surface of the sensing device may alternatively comprise the surface of a circle, the direction along the circumference of the circle being a first direction and the radial direction from the center of the circle outwards forming the second direction. The surface of the circle could be formed by a touch pad, so that activation of the adjustment points can be performed by touching the touch pad in the proper place. Preferably, adjacent adjustment points in one of the directions have the same hue, while adjacent adjustment points in the other direction have the same saturation. It is also possible for the sensing device to comprise a radial slider that can be rotated around the circle, the user action consisting of the positioning of the slider on the surface of the circle. The rotation of the slider can select the hue of the color and adjustment of the radial slide selects the saturation of the color, or alternatively the rotation of the slider can select the saturation of the color and adjustment of the radial slide selects the hue of the color.

Good results have been obtained for embodiments of a lighting device according to the invention, wherein the adjustment points correspond to light of different colors and the same intensity and wherein the user interface is further equipped with means for adjusting the intensity of the light at a number of levels and wherein the memory comprises a color table for each level of the intensity and wherein the user interface is equipped with means for activating the color table corresponding to the adjusted level of the intensity.

As explained hereabove, the color of the light generated by the light source when a particular adjustment point is activated at a first comparatively low intensity level, can often no longer be realized at a higher intensity level. The table for the higher intensity level can for instance ensure that the element of the color table corresponding to the particular adjustment point controls the light at a color that can still be realized and that is closest to the desired color that can not be realized for the adjusted intensity level. Alternatively the element of the table may for instance comprise values for the operational parameters that correspond to a switch off of the light source.

Good results have been obtained for a lighting device according to the invention, wherein the surface of the sensing device comprises the surface of a ball comprised in a housing and means for detecting the orientation of the ball, the adjustment points being present on the surface of the ball and the user action consisting of activating an adjustment point by selecting it by means of a rotation of the ball. Also in this embodiment of course rotation in a first direction may correspond to a change of the hue and rotation in a second direction may correspond to a change in the saturation. Similarly, the first direction of the rotation may be associated with a change in the x value in the CIE chromaticity diagram, while the second direction of rotation may be associated with a change in the y value.

Preferably the surface of the sensing device is equipped with a mapping of adjustable colors or colors and intensities to provide a first orientation to the user regarding the adjustable colors and intensities. Such a color mapping may be untransparant and for instance consist of paint. In such a case, however, for instance in case the actual color of the light generated by the lighting device is red, it becomes impossible for a user to see the true color of the mapped colors. This problem can be avoided in an embodiment, wherein the surface of the sensing device is transparent for visible light and the user interface is equipped with a source of white light for lighting the surface during operation.

In a special embodiment of a lighting device according to the invention, the lighting device is equipped with means for periodically and automatically changing the color of the light, the color difference calculated in the CIELAB color space between subsequent color adjustments of the generated light being the same for each color change. This automatic change is experienced by users as pleasant.

Embodiments of the invention will be further explained, making use of a drawing. In the drawing,

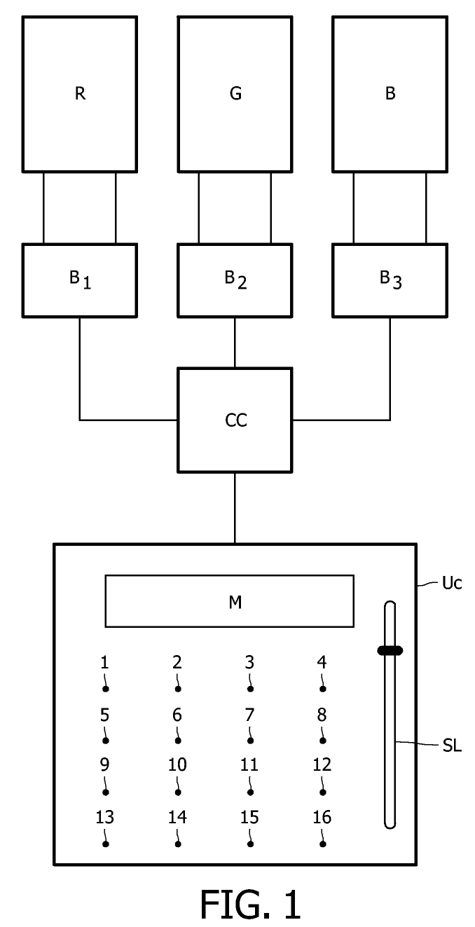

FIG. 1 shows a schematic representation of a lighting device according to the present invention;

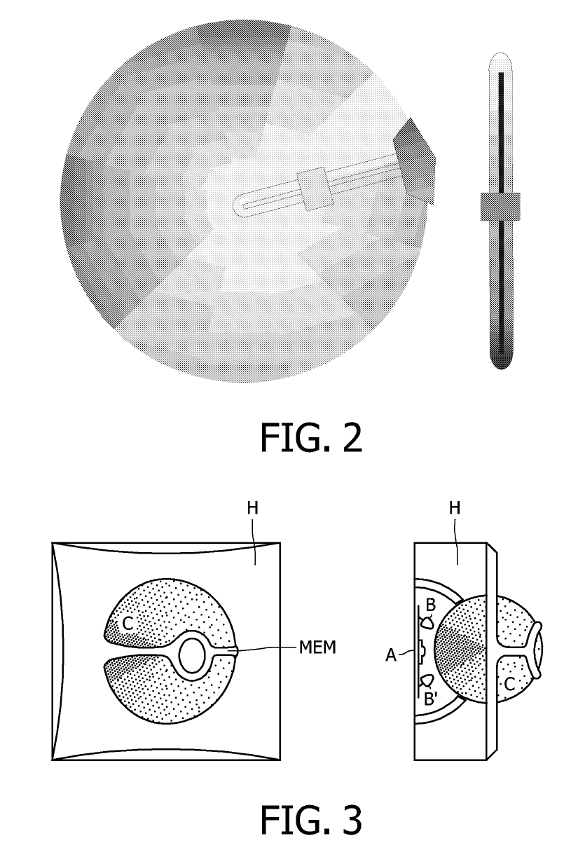

FIG. 2 shows a first embodiment of a user interface suitable for use in the lighting device shown in FIG. 1, and

FIG. 3 shows a second embodiment of a use interface suitable for use in the lighting device shown in FIG. 1.

In the lighting device shown in FIG. 1, R, G and B are light sources for generating red, green and blue light respectively, formed by LED arrays. R, G and B together form a lighting unit. LED arrays R, G and B are coupled with circuit parts B1, B2 and B3. Circuit parts B1, B2 and B3 are ballast circuits for supplying currents to the light sources R, G and B respectively. Circuit part CC, coupled to the ballast circuits B1, B2 and B3, is a control circuit for controlling the operational state of the ballast circuits by adjusting one or more operational parameters. An input of control circuit CC is coupled to an output of user interface UI for adjusting the color or the color and intensity of the light generated by the lighting unit. User interface UI is equipped with a sensing device for sensing a user action resulting in an output signal of the user interface, said output signal adjusting the operational parameters of the ballast circuits B1, B2 and B3 via the control circuit CC. The sensing device comprises a number of adjustment points (1-16) where a user action is possible. Each of the adjustment points corresponds to a different color of the light generated by the lighting unit. The user interface UI is further equipped with a slider SL for adjusting the intensity of the light at a number of predetermined values. The user interface is also equipped with a memory M for storing a color table for each of the adjustable intensity values and with means (not shown) for activating the color table corresponding to the adjusted intensity level. Each of the adjustment points corresponds to an element of the color table and each element of the color table comprises data determining the values of the operational parameters of the ballast circuits. The adjustment points are arranged in four columns and four rows. Adjacent adjustment points in the same row correspond to colors of the generated light having the same value of the saturation but a different value of the hue. Adjacent adjustment points in the same column correspond to colors of the generated light having the same value of the hue but a different value of the saturation. The color difference calculated in the CIELAB color space between the generated light corresponding to adjacent adjustment points in a row is the same and equal to a first value for at least part of the adjacent adjustment points in said row and the color difference calculated in the CIELAB color space between the generated light corresponding to adjacent adjustment points in a column is the same and equal to a second value for at least part of the adjacent adjustment points in said column. These parts of the adjustment points in the rows and in the columns correspond to the range over which the color can be adjusted in equidistant steps. It is observed that the first and the second value are not necessarily equal.

A user of the lighting device shown in FIG. 1 can select the desired hue of the light by subsequently activating adjustment points in the same row. Since the difference in color between any two adjacent adjustment points (belonging to the part for which the color difference calculated in the CIELAB space is the same) is perceived by the user as the same, this selection is relatively easy. Once the desired hue is selected, the desired saturation can be selected by subsequently activating adjustment points in the same column. Also this selection is relatively easy, since the difference in color between any two adjacent adjustment points (belonging to the part for which the color difference calculated in the CIELAB space is the same) is perceived by the user as the same.

In the embodiment shown in FIG. 1 the number of adjustment points is chosen equal to 16. It is noted that this is purely by way of example and that the number of adjustment points can be chosen preferably (much) larger but also smaller. The adjustment points can for instance be formed by push buttons or membrane switches, but other possibilities exist. To facilitate the selection of color by a user even further, it is possible to apply a mapping of adjustable colors on the sensing device.

It is important to note that when the adjusted intensity is lower, the range over which the color can be adjusted is generally bigger. As a consequence the part of the adjacent adjustment points in a row or in a column for which the color difference calculated in the CIELAB color space between the generated light is the same, can also be bigger when the total light intensity is smaller. For the remainder of the adjacent adjustment points in a row or in a column, the color difference calculated in the CIELAB color space cannot be the same. Several options exist for the color and intensity of the light that is generated when one of the adjustment points belonging to the remainder of the adjustment points is activated by means of a user action.

In case for instance the maximal light output of the red light source is not high enough to realize the desired color at the adjusted intensity of the light generated by the three light sources together, the information in the color table(s) can for instance be so that the lighting device reacts to this situation by adjusting the red light source at maximum light output and adjusting the green and blue source to such light outputs that the total light output of the three light sources together corresponds to the adjusted intensity. However, in that case the color of the light will differ from the desired color. Alternatively, the lighting device could be so constructed that in that case the red light source is adjusted at maximum light output and the green and blue source to such outputs that the color of the light corresponds to the desired color. In this latter case the intensity is lower than the adjusted intensity. Other solutions do exist. Which one is preferable depends on the application of the lighting device.

The alternative user interface shown in FIG. 2 is equipped with a slider to adjust the intensity of the generated light. The sensing device has a circular surface and comprises a radial slider that can be rotated around the circle. Adjustment points are present on the circular surface and are activated when a user positions the slider on an adjustment point. When the slider is rotated at a constant radius adjustment points corresponding to color settings with a different hue but with a constant saturation are subsequently activated. When the slider is moved in a radial direction, adjustment points with a different saturation but the same hue are subsequently activated. Also when use is made of this user interface, a user can easily arrive at the desired color setting by subsequently selecting the desired hue (by rotating the slider) and the desired saturation (by moving the slider in a radial direction). Also in case of this user interface, the color change perceived by a user when adjacent adjustment points in one direction (in this case radial or circumferential) are subsequently activated is the same over part of the surface of the circle. (The color difference between adjacent adjustment points in circumferential direction may still differ from the color difference between adjacent adjustment points in radial direction.) This part of the circle corresponds to the range within which the color can be adjusted in equidistant steps and is bigger when the total intensity is adjusted at a lower level. The surface of the circle is equipped with a color mapping to provide further assistance to a user in selecting the desired color of the generated light. Preferably, by rotating the slider, the color of the light is subsequently changed from (deep) red, via orange, yellow, green, blue and indigo to violet. This sequence corresponds to the sequence of colors in a rainbow.

It is noted that an equally user friendly interface can be realized in case the rotation of the slider selects the saturation of the color and adjustment of the radial slide selects the hue of the color.

In an alternative embodiment of this user interface, the circular surface is put on a touching device (e.g. capacitive sensing devices, like a touch pad, or a touch screen) and the revolving slider is replaced by the user's finger that points to an adjustment point.

The advantage of these user interfaces with a color representation that is displayed or printed on the surface of the user interface, is that the user gets an impression of the colors that can be created with the light source. An untrained user will easily understand how to change color for instance from a saturated blue to a weakly saturated orange in a very rapid way. The graphical color representation will help to understand more easily what the possibilities with color saturation are.

Using the slider or a touch screen, the user can see the last set color (the slider will indicate the point and with a touch screen a marker can be left on the displayed graph). In case of a touch pad, it is possible to mark the last set color with a small LED light source below the printed colors, that lit the last selected color from the back side (on the condition that the touch pad is semi-transparent).

In a more basic embodiment of this user interface the circular surface and the revolving slider are replaced by a three one-dimensional sliders: a circular slider for hue and two linear sliders for saturation and brightness.

In the user interface shown in FIG. 3, C is a ball that is mounted in a housing H. This mounting is such that the ball can be rotated in each direction. MEM is a member comprised in the house H that prevents the ball from falling out of the house H. Furthermore, the member comprises a circular opening. Adjustment points are present on the surface of the ball and the ball has a mapping of the selectable colors on its surface. A user rotates the ball until the desired color is present within the circular opening of the member MEM. On the opposite side of the surface of the ball, a color that is complementary to the color selected by the user is present and is detected by a sensor A mounted in the housing. The sensor forms means for detecting the orientation of the ball. The signal generated by the sensor activates the proper element in the color table comprised in the memory of the user interface. B are sources of white light mounted in the housing H, ensuring that the sensor detects a proper light color.

The adjustment points are arranged on the surface of the ball in such a way, that rotation of the ball in a first direction allows a user to select the hue of the generated light. Preferably, red, orange, green, blue, indigo and violet are mapped in that order on the surface of the ball in his first direction. Rotation in a second direction (perpendicular to the first one) allows the user to select the saturation of the generated light. Once more the colors corresponding with adjacent adjustment points in each of the two perpendicular directions are chosen such that a user perceives an identical change in color for any two adjacent adjustment points over part of the surface of the ball. This is true because the distance between the color points of the generated light calculated in the CIELAB color space is the same over part of the surface. Also in case of this user interface, this is the reason why the user can relatively easily select a desired color.

The material that the ball is made of an be chosen transparent for visible light and a source of white light can be mounted in the inside of the ball. In that way the user can see the proper color of the mapping on he surface of the ball irrespective of the color of the light generated by the lighting unit.

The selected color is determined by measuring the color on the opposite side of the ball, e.g. by a color sensor that measures the color opposite to the selected color and by a using a lookup table to determine the selected color.

1. A lighting device comprising
a lighting unit comprising light sources for generating red, green and blue light,
ballast circuitry for supplying supply currents to the light sources in the lighting unit,
a control circuit for controlling the operational state of the ballast circuitry by adjusting one or more operational parameters, and
a user interface, coupled to the control circuit, for adjusting the color or the color and intensity of the light generated by the lighting unit, said user interface being provided with a sensing device for sensing a user action resulting in an output signal of the user interface, said output signal adjusting the operational parameters via the control circuit, said sensing device being provided with a number of adjustment points where a user action is possible, each of the adjustment points corresponding to a different color and/or intensity of the light generated by the lighting unit, characterized in that the lighting device is equipped with a memory for storing a color table, each adjustment point corresponding to an element of the color table and each element of the color table comprising data determining the values of the operational parameters of the ballast circuitry corresponding to the adjustment point, and in that the color difference calculated in the CIELAB color space between the color points of the generated light corresponding to adjacent adjustment points is the same for a fraction of the adjustment points.

2. A lighting device as claimed in claim 1, wherein part of the adjustment points corresponds to light with the same color but with a different intensity.

3. A lighting device as claimed in claim 1, wherein part of the adjustment points corresponds to light with the same intensity but with a different color.

4. A lighting device as claimed in claim 1, wherein part of the adjustment points corresponds to light with the same color saturation but with a different hue.

5. A lighting device as claimed in claim 1, wherein part of the adjustment points corresponds to light with the same hue but a different color saturation.

6. A lighting device as claimed in claim 1, wherein part of the adjustment points corresponds to light with the same value of the x-coordinate but a different value of the y-coordinate in the CIE chromaticity diagram.

7. A lighting device as claimed in claim 1, wherein part of the adjustment points corresponds to light with the same y-coordinate but a different value of the x-coordinate in the CIE chromaticity diagram.

8. A lighting device as claimed in claim 1, wherein the adjustment points are present on a surface comprised in the sensing means and wherein the color difference calculated in the CIELAB color space between the generated light corresponding to adjacent adjustment points in a first direction is the same and equal to a first value for at least part of the adjacent adjustment points in said first direction and the color difference calculated in the CIELAB color space between the generated light corresponding to adjacent adjustment points in a second direction is the same and equal to a second value for at least part of the adjacent adjustment points in said second direction.

9. A lighting device as claimed in claim 8, wherein the surface of the sensing device comprises the surface of a circle and wherein the first direction is along the circumference of the circle and the second direction is from the center of the circle along a radius.

10. A lighting device as claimed in claim 9, wherein the sensing device comprises a radial slider that can be rotated around the circle, the user action consisting of the positioning of the slider on the surface of the circle.

11. A lighting device as claimed in claim 8, wherein adjustment points in one of the directions correspond to color points of the generated light with an equal value of the saturation but with different values for the hue and wherein adjustment points in the other direction correspond to color points of the generated light with an equal value of the hue but with different values of the saturation.

12. A lighting device as claimed in claim 10, wherein rotation of the slider selects the hue of the color and adjustment of the radial slide selects the saturation of the color.

13. A lighting device as claimed in claim 10, wherein rotation of the slider selects the saturation of the color and adjustment of the radial slide selects the hue of the color.

14. A lighting device as claimed in claim 1, wherein the sensing device comprises a ball comprised in a housing and means for detecting the orientation of the ball, the adjustment points being present on the surface of the ball and an adjustment point being selected by a user by means of a rotation of the ball.

15. A lighting device as claimed in claim 1, wherein the surface of the sensing device is equipped with a mapping of adjustable colors and/or intensities.

16. A lighting device as claimed in claim 15, wherein the surface of the sensing device is transparent for visible light and the user interface is equipped with a source of white light for lighting the surface during operation.

17. A lighting device as claimed in claim 1, wherein the lighting device is equipped with means for periodically and automatically changing the color of the light, the color difference calculated in the CIELAB color space between subsequent color adjustments of the generated light being the same for each color change.

18. A lighting device as claimed in claim 1, wherein the adjustment points correspond to light of different colors and the same intensity and wherein the user interface is further equipped with means for adjusting the intensity of the light at a number of levels, wherein the memory comprises a color table for each level of the intensity and wherein the user interface is further equipped with means for activating the color table corresponding to the adjusted level of the intensity.

19. A lighting device as claimed in claim 1, wherein the adjustment points are formed by push buttons.

20. A lighting device as claimed in claim 1, wherein the adjustment points are formed by membrane switches.

21. A lighting device as claimed in claim 1, wherein a separate table and/or formula is used to determine the relation between adjustment points and elements of the color table.
